(19) United States
(12) Patent Application Publication
(10) Pub. No.: US 2020/0311037 A1
(43) Pub. Date: Oct. 1, 2020

(54) STATE INFORMATION FILE LOCATIONS BASED ON VERSION NUMBER

(71) Applicant: HEWLETT PACKARD ENTERPRISE DEVELOPMENT LP, Houston, TX (US)

(72) Inventor: Dhanwa Thirumalai, Bangalore (IN)

(21) Appl. No.: 16/820,588

(22) Filed: Mar. 16, 2020

(30) Foreign Application Priority Data
Mar. 27, 2019 (IN) 201941012085

(51) Int. Cl. G06F 16/182; G06F 16/18; G06F 16/16

(52) U.S. Cl. CPC G06F 16/1844; G06F 16/166; G06F 16/1873

(57) ABSTRACT

Example implementations relate to state information at a file location named with a version number. In an example, a data store stores replica state information having a file location named with a first version number. A second version number is received from a consensus protocol, and the file location of the state information is rename with the second version number. The replica state information is updated at the file location named with the second version number while servicing requests for client data.

### BACKGROUND

Computing systems may store data. Data may be served via storage protocols, some of which may be stateful. Computing systems may operate to store data with high or continuous availability. For example, data may be replicated between computing systems in a failover domain, and a computing system may take over storage access responsibilities for a failed computing system.

### BRIEF DESCRIPTION OF THE DRAWINGS

Various examples will be described below with reference to the following figures.

FIG. 1 illustrates an example cluster where a file location of state information is renamed with a version number received from a consensus protocol.

FIG. 2 is a sequence diagram depicting example interactions including interactions that rename a file location of state information with a version number received from a consensus protocol.

FIG. 3 is a block diagram depicting a machine readable medium encoded with example instructions to rename a file location of state information with a version number received from a consensus protocol.

FIG. 4 is a flow diagram depicting an example method that renames a file location of state information with a version number received from a consensus protocol.

FIG. 5 is a flow diagram depicting an example method after a virtual controller rejoins a cluster upon healing of a network partition.

### DETAILED DESCRIPTION

Data may be stored on computing systems, such as servers, computer appliances, workstations, storage systems, converged or hyperconverged systems, or the like. To store data, some computing systems may utilize a data virtualization platform that abstracts aspects of the physical storage hardware on which the data is physically stored (e.g., aspects such as addressing, configurations, etc.) and presents virtualized or logical storage to a user environment (e.g., to an operating system, applications, processes, etc.). The virtualized storage may be pooled from multiple storage hardware (e.g., hard disk drives, solid state drives, etc.) into a data store, out of which the virtualized or logical storage may be provided. The data virtualization platform may also provide data services such as deduplication, compression, replication, and the like. In some implementations, the data virtualization platform may be implemented, maintained, and managed by, at least in part, a virtual controller. A virtual controller may be a virtual machine executing on hardware resources, such as a processor and memory, with specialized processor-executable instructions to establish and maintain virtualized storage according to various examples described herein.

In some instances, a data virtualization platform may be object-based. An object-based data virtualization platform may differ from block level storage (e.g., implemented in storage area networks and presented via a storage protocol such as iSCSI or Fibre Channel) and file level storage (e.g., a virtual file system which manages data in a file hierarchy and is presented via a file protocol such as NFS or SMB/CIFS), although an object-based data virtualization platform may underlie block or file storage protocols in some implementations. In an object-based platform, data may be stored as objects in an object store, which may serve as or form part of the aforementioned data store. User accessible files and directories may be made up of multiple objects. Each object may be identified by a signature (also referred to as an object fingerprint), which, in some implementations, may include a cryptographic hash digest of the content of that object. The signature can be correlated to a physical address (i.e., disk location) of the object's data in an object index.

Objects may be hierarchically related to a root object in an object tree (e.g., a Merkle tree) or any other hierarchical arrangement (e.g., directed acyclic graphs, etc.). The hierarchical arrangement of objects may be referred to as a file system instance. In some instances, one or more file system instances may be dedicated to an entity, such as a particular virtual machine, a user, or a client. Objects in an object store may be referenced in one or more file system instances.

As previously noted, a data virtualization platform may underlie block or file storage protocols. For example, a client (e.g., a guest virtual machine) can connect to an IP address (also referred to as a storage IP address) of a virtual controller managing a data virtualization platform and access data of a file system instance of the data virtualization platform via a file protocol mount point (e.g., an NFS or SMB mount point) exported by the data virtualization platform. A file at the file protocol level (e.g., user documents, a computer program, etc.) may be made up of multiple data objects within the data virtualization platform. Some file protocols, (e.g., Server Message Block (SMB), the Samba implementation of SMB, Network File System version 4 (NFS v4), etc.) may be stateful, meaning that a client establishes a session to access files, and state information about an open session is maintained by the file protocol until the session closes. State information may include information about the network connection between the client and the server (i.e., virtual controller and data virtualization platform), persistent handles, share mode locks, etc. State information may be stored alongside client data in a data store.

In order to provide high or continuous availability of data, computing systems may be arranged into failover domains. For example, a failover domain may be a networked cluster of computing systems, also referred to as a cluster of nodes. In some cases, data may be replicated between two or more nodes in the cluster. Occasionally, a node may become unavailable to service client requests to access data. Unavailability may arise, for example, due to a network partition, a partial or complete failure of that node, a disconnection of that node from the network, or other situations. In case of such unavailability, another node in the cluster (also referred to as a “failover node”) may take over responsibility for servicing requests intended for the unavailable node according to a failover routine, using a local replica of some or all of the unavailable node's data or a replica stored on another node in the cluster.

It may be also useful to make state information utilized by the unavailable node prior to the unavailability available to the failover node so that the failover node can continue to service existing sessions. The failover node may update the state information while the other unavailable node remains unavailable. However, when the unavailable node rejoins the cluster, that node may attempt to continue with the state information unaware of updates that had been made, thus possibly corrupting the state information. For example, the rejoined node may overwrite current state information with stale data.

Corruption of state information under the above scenario may be avoided if the unavailable node is forced to forget all state information, by way of a reboot for example. However, forcing the unavailable node to forget all state information may disrupt service to some clients in some instances, such as service to virtual machines on the node itself that continue to have access to the node's data virtualization platform even while that node became unavailable to clients over the network.

Thus, it may be useful to maintain control over access to state information in fail over situations to avoid corruption of the state information. Examples disclosed herein may relate to, among other things, a second virtual controller assuming ownership of a first data store of a first virtual controller in response to a network partition between a first virtual controller and a second virtual controller in a cluster or transient failure of one of the nodes or switches of the network. The second virtual controller serves requests for client data of the first data store via a file protocol from replicated client data and state information, which is initially at a file location named with a first version number. The second virtual controller receives a second version number from a consensus protocol and renames the file location with the second version number. The second virtual controller updates the state information at the file location named with the second version number while serving requests during the network partition. By virtue of renaming the state information file location, the first virtual controller may be prevented from corrupting the state information upon rejoining the cluster. The techniques described herein are not limited to stateful file protocols, but may also be adapted to protect state information in other distributed architectures that utilize consensus protocols and are stateful, such as such as MongoDB.

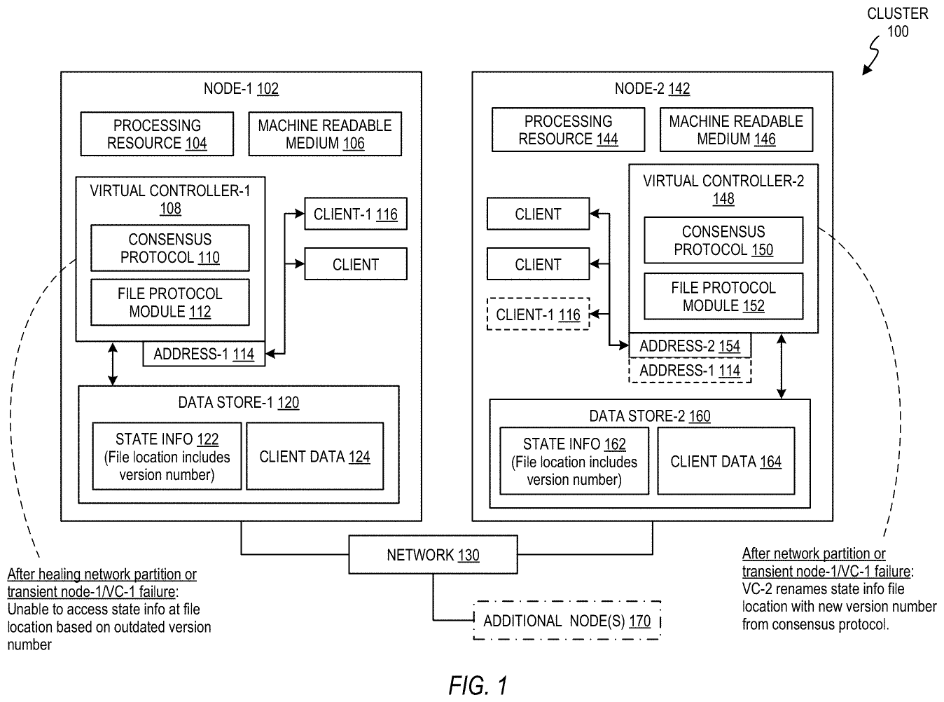

Referring now to the figures, FIG. 1 illustrates an example cluster 100 that includes a first node, node-1 102, in communication with a second node, node-2 142, over a network 130, which may include any wired and/or wireless network technology. In other words, node-1 102 and node-2 142 may both be joined to the same cluster 100. Although the example described herein refers to two nodes for convenience, the principles described herein are also applicable to clusters that include one or more additional nodes 170. Each of node-1 102 and node-2 142, as well as any additional nodes 170, may be a server, a computer appliance, a workstation, a storage system, a converged or hyperconverged system, or the like. Cluster 100 may be deemed a distributed computing system.

Many features of node-1 102 are analogous in many respects to corresponding features of node-2 142. For example, processing resource 104, machine readable medium 106, virtual controller-1 108, consensus protocol 110, file protocol module 112, address-1 114, and data store-1 120 of node-1 120 may be analogous, at least in terms of functionality, to processing resource 144, machine readable medium 146, virtual controller-2 148, consensus protocol 150, file protocol module 152, address-2 154, and data store-2 160 of node-2 142. Merely for clarity and convenience, features and components of node-1 102 may be described herein as “first” (e.g., first virtual controller, first data store, etc.) and features and components of node-2 142 may be described as “second” (e.g., second virtual controller, second data store, etc.), without connoting sequence. Features and components of node-1 102 will now be described, and it may be appreciated and understood that such description also may apply to analogous features and components of node-2 142.

Node-1 102 includes a processing resource 104 and a machine readable media 106. For example, a processing resource may include a microcontroller, a microprocessor, central processing unit core(s), an application-specific integrated circuit (ASIC), a field programmable gate array (FPGA), etc. A machine readable medium may be non-transitory and include random access memory (RAM), read-only memory (ROM), electrically erasable programmable read-only memory (EEPROM), flash memory, a hard disk drive, etc. A processing resource may execute instructions (i.e., programming or software code) stored on the machine readable medium. Additionally or alternatively, a processing resource may include electronic circuitry for performing the functionality described herein.

Node-1 102 also includes a virtual controller-1 108 (also denoted as VC-1 on FIG. 1), which may be implemented using hardware devices (e.g., electronic circuitry, logic, or processors) or any combination of hardware and programming (e.g., instructions stored on machine readable medium) to implement various functionalities described herein. For example, in an implementation, the virtual controller-1 108 may be a virtual machine that comprises, at least in part, instructions stored on the machine readable medium 106 and executing on the processing resource 104. The virtual controller-1 108 may provide a data virtualization platform, which includes abstracting underlying physical storage, such as hard disk drives or solid state drives, of the node-1 102 to provide a data store-1 120. In some implementations, the data store-1 120 may include an object store that stores data, such as files and directors, as objects identifiable by content-based hash signatures and related in a hierarchical arrangement.

The virtual controller-1 108 may export a file protocol mount point to make the data of the data store-1 120 accessible. For example, node-1 102 may host clients, such as client-1 116, which may be guest virtual machines. Client-1 116 and virtual controller-1 108 may be virtual machines running on a same hypervisor of the node-1 102. Client data 124 may be stored in the data store-1 120. Additional client data (not shown) may be stored in the data store-1 120. In an example, client data 124 may be a file system instance associated specifically with client-1 116. More generally, in an example implementation, data store-1 120 may store sets of client data, each being separate file system instances that are associated with respective clients (e.g., guest virtual machines).

To illustrate, in operation, client-1 116 may connect with the virtual controller-1 108 via address-1 114 and communicate data access requests (e.g., open, read, write, rename, move, close, etc.) using a file protocol, such as SMB v3. The file protocol module 112 may receive the requests and make corresponding system calls (syscalls) to the portions of the virtual controller-1 108 that manage the data store-1 120, that is, to the data virtualization platform. For example, the file protocol module may make open, close, read, or write syscalls against the mount point associated with client data 124. In some implementations, file protocol module 112 may be Samba software. In a similar manner, virtual controller-2 148 (also denoted as VC-2 on FIG. 1) similarly can receive requests via address-2 154 and act on the requests via file protocol module 152 and data store-2 160.

The file protocol and the file protocol module 112 may be stateful, in which case, the file protocol module 112 creates, maintains, and utilizes state information 122 to service requests and serve the client data 124 via the file protocol. State information may relate to the network connection of the file protocol to the client data 124. State information may include persistent handles, share-mode locks, and the like. The state information 122 may be stored in data store-1 120. In implementations where the data virtualization platform is object-based, the state information 122 itself may be comprised of objects organized in a file system instance. The virtual controller-1 108 may export the data store-1 120 to a file protocol mount point for use by the file protocol module 112. In particular, the state information 122 may be at a file location named with a version number for the client data 124 (i.e., a first version number, in contrast to a second version number to be described below). For example, the version number may be embedded in a virtual disk name portion of the file location (e.g., “/mnt/stateinfo/ . . . /StateInformation/disk.vhd/<version-number>). As another example, the version number may be embedded in a directory path portion of the file location (e.g., “/mnt/stateinfo/ . . . /disk.vhd<version-number>/StateInformation.db”).

The cluster 100 and nodes thereof may be deemed a distributed computing system. The virtual controller-1 108 and the virtual controller-2 148 may include respective instances of a consensus protocol 110, 150 that coordinate within the cluster 100 via network 130. For example, consensus protocol 110, 150 may be based on Paxos or Raft consensus protocols. The consensus protocol 110, 150 may maintain consistency of state information, configuration information, and the like, within the cluster 100. Moreover, the consensus protocol 110, 150 may provide the version number for the state information 122, via an application programming interface (API), programming hook, or the like, for example. In an implementation, the consensus protocol 110, 150 may be configured to monotonically increase version numbers for each set of state information independently. Some example conditions triggering a new version number will be described below.

To provide high or continuous availability of data, virtual controller-1 108 and virtual controller-2 148 may coordinate replication of data in the data stores. For example, virtual controller-1 108 may store client data 124 for client-1 116. The client data 124 may be replicated to data store-2 160 as client data 164. The state information 122 may also be replicated to data store-2 160 as state information 162. Thus, data store-2 160 may store replica client data and replica state information. In various implementations, replication may be performed by virtual controller-1 108, virtual controller-2 148, or virtual controller-1 108 in cooperation with virtual controller-2 148. The replication may be synchronized, that is, the replicated copies—client data 164 and state information 162—may be kept current with any changes to client data 124 and state information 122, while virtual controller-1 108 and virtual controller-2 148 are able to communicate. In particular, the replica state information 162 may have a file location named with the same version number as the state information 122.

The virtual controller-1 108 may include a quorum mechanism and policies that are based on placement of replica client data to determine whether replica data can be accessed by clients. In particular, if a network partition occurs and node-1 102 and node-2 142 are separated, the quorum mechanism allows clients on those nodes to continue to access collocated client data or replica client data.

Each virtual controller in the cluster 100, including virtual controller-1 108 and virtual controller-2 148, can detect network partitions (separation of nodes of the cluster 100) or transient failures of nodes or peer virtual controllers in the cluster 100. In response, a failover routine occurs where a virtual controller (“failover controller”) may take over ownership of the IP address of a failed or inaccessible virtual controller according to the quorum mechanism, recover a session from replica state information (e.g., via persistent handles), and service requests based on replica client data in order to provide data high availability to clients on the subnet where the failover controller is operative.

In an example scenario, network 130 may fail, thus causing a network partition between node-1 102 and node-2 142 and between the virtual controllers thereof. In another example scenario, the virtual controller-1 108 of node-1 102 may fail and cannot communicate with virtual controller-2 148 of node-2 142, but node-1 102 and clients running thereon may remain operational. For example, virtual controller-1 108 as a virtual machine may fail, but the hypervisor environment hosting virtual controller-1 108 and the client virtual machines may remain operational. In such an example, client-1 116 may remain operational on node-1 102 or may be migrated (by the hypervisor system) to node-2 142, as indicated by client-1 116 in dashed lines in node-2 142 on FIG. 1.

In any case, virtual controller-2 148 may take over address-1 114 (shown in dashed lines in node-2 142 on FIG. 1) in accordance with the quorum mechanism by virtue of remaining in operation and having a replica of client data 124 (i.e., client data 164). Using the address-1 114, virtual controller-2 148 may service file protocol requests for client data that are intended for node-1 102 and virtual controller-1 108 (e.g., requests directed at client data 124). In particular, virtual controller-2 148 may recover a stateful session from persistent handles in the replica state information 162. In this manner, virtual controller-2 148 can provide data high availability on the subnet that virtual controller-2 148 is part of and particularly to any clients on that subnet, including any migrated clients.

After a failover process has been executed and virtual controller-2 148 has taken over address-1 114 and is ready to serve client data 164 using state information 162, virtual controller-2 148 performs the following process to protect state information 162 from being corrupted after node-1 102 and/or virtual controller-1 108 later rejoins the cluster 100 and attempts to update the state information. To protect the state information, the virtual controller-2 148 renames the file location of the state information 162 so that it cannot be found by the rejoined virtual controller-1 108.

Prior to renaming the file location however, virtual controller-2 148 may first identify what the outgoing version number is, in an implementation. For example, the virtual controller-2 148 may use a readdir command to select a directory or virtual disk name with the maximum value, which represents the latest version number. In another example, the virtual controller-2 148 may retrieve an extended attribute associated with the client data virtual disk, where the returned extended attribute is the outgoing version number.

The virtual controller-2 148 renames the identified outgoing version number embedded in the file location of the state information 162 using a new version number acquired in a manner that will now be described. After virtual controller-1 108 and the address-1 114 thereof has failed over to virtual controller-2 148, the virtual controller-2 may receive a new, second version number from the consensus protocol 150. As noted above, the consensus protocol may be configured to monotonically increase version numbers, and thus, the second version number is not equal to the first version number and may be greater than the first version number. From the perspective of the consensus protocol, determining a second version number may be understood as the consensus protocol incrementing a version number for the state information of a set of client data.

In an implementation, the consensus protocol 150 may be automatically triggered to determine the second version number in response to detection of the network partition, node failure, or virtual controller failure. In another implementation, the file protocol module 152 processing a file protocol request to connect to the client data 164 (e.g., open request) may trigger the consensus protocol 150 to determine the second version number. Because virtual controller-1 108 and thus consensus protocol 110 are unavailable, consensus protocol 150 acts either alone or with other consensus protocol instances in communication via network 130.

In an implementation, the virtual controller-2 148 may receive the second version number by retrieving a value of an extended attribute associated with the client data 164. For example, the virtual controller-2 148 may execute a command such as getxattr(disk.vhd, getCurrentVersionLocation) to retrieve the extended attribute parameter “getCurrentVersionLocation”. The file protocol module 152 may process the extended attribute retrieval by making a syscall to the data virtualization platform of virtual controller-2 148. The particular extended attribute “getCurrentVersionLocation” may be associated with a programming hook, kernel driver, API, or the like, that causes the data virtualization platform to call the consensus protocol 150 to return the version number, which has been incremented to the second version number by any of the triggers discussed above (and is thus the “current” version number from the perspective of the consensus protocol). The data virtualization platform may embedded the second version number from the consensus protocol 150 into a path and return that path with the second version number as the result value for the extended attribute. In the example above, a getxattr command may be deemed a virtual getxattr, since the extended attribute is not written in the file system (i.e., in the actual path of the client data 164 or state information 162), but is hooked in from the consensus protocol 150.

In an implementation, the virtual controller-2 148 may explicitly request the consensus protocol 150 to increment the version number. For example, the getCurrentVersionLocation extended attribute hook may cause the consensus protocol 150 to explicitly increment the version number each time it is called. Other APIs or hooks may be used to request the consensus protocol 150 to explicitly increment the version number.

In another implementation, the virtual controller-2 148 may receive the second version number by reading a virtual file having therein the second version number from the consensus protocol 150. In an implementation, a “/proc” command can be used to read the virtual file system, and in particular, to read a virtual file /proc/ . . . /disk.vhd/currentVersionLocation. Reading the currentVersionLocation as a virtual file via /proc may cause the consensus protocol 150 to return a version number, namely the incremented second version number, via a programming hook, kernel driver, API, or the like.

The virtual controller-2 148 then renames the file location of the replica state information 162 using the second version number, in an implementation. In another implementation, the virtual controller-2 148 may copy the replica state information 162 or create a new set of state information, and then name or rename the copy or the new state information with the second version number. The second version number may be named or renamed in the directory path portion of the file location or a virtual disk name portion of the file location.

As noted previously, the consensus protocol 150 may increment the version number as triggered by various circumstances, including detection of network partition or virtual controller/node unavailability and/or upon a connection request after fail over. Accordingly, the file location may be renamed following any time the version number is incremented. For example, the file location may be renamed after detection of a network partition (e.g., to a second version number) and then renamed again upon a connection request that creates a new set of state information (e.g., to a third version number).

After the file location has been renamed, the virtual controller-2 148 may serve data from replica client data 164, in response to file protocol requests from client-1 116 on node-1 102 over the network 130, a migrated client-1 116 on node-2 142, or any other client authorized to access client data 164. As the replica client data 164 is being served, virtual controller-2 148 and file protocol module 152 in particular may update the associated state information 162 at the file location renamed with the second version number.

Eventually, virtual controller-1 108 may rejoin the cluster 100 after the issue precipitating unavailability and subsequent failover has resolved. For example, a network partition may have healed or the virtual controller-1 108 may have restarted. Rejoining the cluster 100 may also include failback operations, where the virtual controller-1 108 regains control of address-1 114 and primary responsibilities for serving client data 124. After virtual controller-1 108 rejoins the cluster 100, the virtual controller-1 108 and virtual controller-2 148 may cooperate to synchronize the updated state information 162 from data store-2 160 to date store-1 120. For example, the synchronization may utilize the replication mechanism described above.

In some instances, the virtual controller-1 108 may have cached the file location of the state information named with the first version number prior to the network partition or other unavailability. Since the updated state information synchronized back to data store-1 120 is at a file location named with the second version number (or an even higher version number if incremented multiple times after failover), the virtual controller-1 108 will be unable to access the state information 122 using the cached file location bearing the outdated first version number. In this manner, state information 122 that has been synchronized with updates will be protected from being corrupted with stale data from virtual controller-1 108. If client-1 116 starts sending requests again to virtual controller-1 108 via address-1 114, client-1 116 may provide the correct version number (i.e., second version number) to the virtual controller-1 108. The virtual controller-1 108 can then continue a session indicated in updated state information 122.

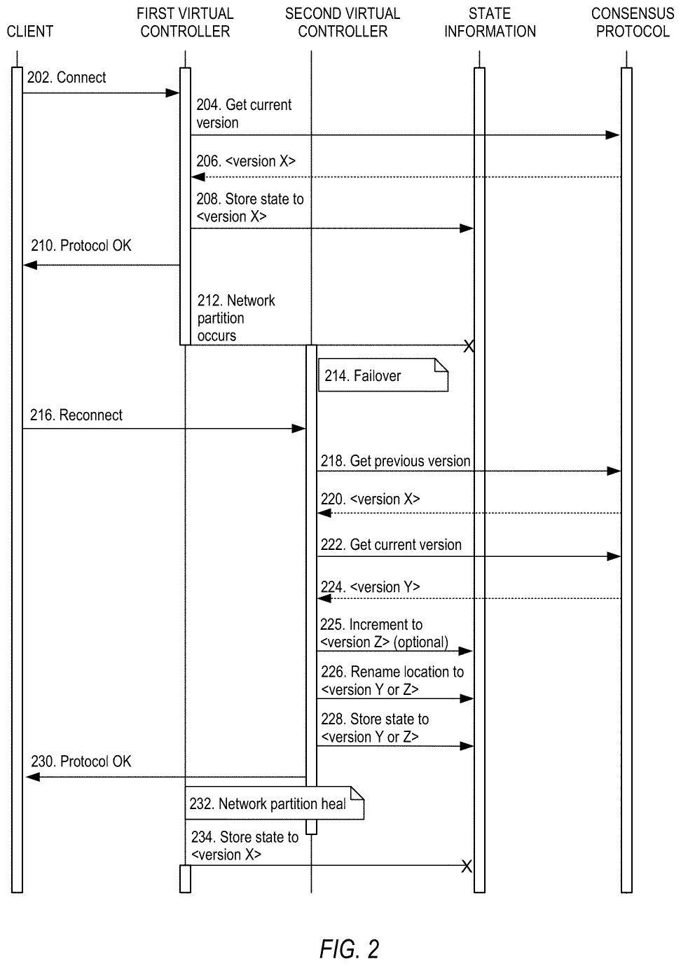

FIG. 2 is an example sequence diagram. The objects include a client, a first virtual controller, a second virtual controller, state information, and a consensus protocol. The client may be analogous in to client-1 116 (on node-1 102 or migrated to node-2 142). The first virtual controller may be analogous to virtual controller-1 108. The second virtual controller may be analogous to virtual controller-2 148. The state information may be analogous to the replicated and synchronized state information 122, 162. The consensus protocol may be analogous to consensus protocol 110, 150.

At 202, the client connects to the first virtual controller. For example the client may send a file protocol request to open client data (e.g., client data 124). At 204, the first virtual controller may get the current version number associated with client data of the open request from the consensus protocol. This current version number may be a new incremented number in some implementations. At 206, version X is returned from the consensus protocol, and, at 208, the first virtual controller can store state information at a file location named with version X for a session associated with the open request of 202. The first virtual controller can signal back a file protocol status OK to the client at 210.

At 212, a network partition occurs whereby, among other effects, the first virtual controller loses access to the state information. At 214, the first virtual controller may fail over to the second virtual controller, which may include the second virtual controller assuming a storage IP address of the first virtual controller. At 216, the client reconnects to the second virtual controller at the storage IP address.

At 218, the second virtual controller gets the outgoing, previous version number from the consensus protocol (e.g., the first version number described above). For example, the second virtual controller may use a readdir command to identify the maximum value among existing file or folder of state information, which would correspond to the last version number because version numbers monotonically increase. In another example, the second virtual controller may use a getxattr command to retrieve an extended attribute of the state information that retrieves the previous version number from the consensus protocol. At 220, the consensus protocol returns version X to the second virtual controller.

At 222, the second virtual controller gets the current version number from the consensus protocol. The consensus protocol will have either incremented the version number automatically as part of the 214 failover or will increment the version number as in response to the 222 request for current version number. At 224, the consensus protocol returns version Y to the second virtual controller. Version Y may be greater than version X, according to a monotonically increasing series maintained by the consensus protocol.

In some implementations, at 225, the second virtual controller may explicitly request an increment in the version number from the consensus protocol, to version Z for example. Explicitly requesting a version number increment may be implemented in some cases to provide a backup in case the version number fails to increment during the failover routine at 214. In other cases, 225 may be optional.

At 226, the second virtual controller may rename the file location to version Y or version Z, depending on whether 225 was implemented. The second virtual controller may rename the file location of the existing state information to the current version number (version Y or Z), may create a new set of state information in a file location named by the current version number, or may copy the existing state information and rename the file location of the copied state information to the current version number.

At 228, the second virtual controller may store state information to the location at version Y or Z, depending on whether 225 was implemented, as client data requests are being served. The second virtual controller may signal back a file protocol status OK to the client at 230.

At 232, the network partition or other unavailability may heal. At 234, the first virtual controller may attempt to store state information using the version X file location but will fail, because the file location has been updated to version Y or Z. For example, the first virtual controller may be attempting to write outdated state information from before the 212 network partition. Accordingly, the state information updated at 228 may be protected from corruption by first virtual controller.

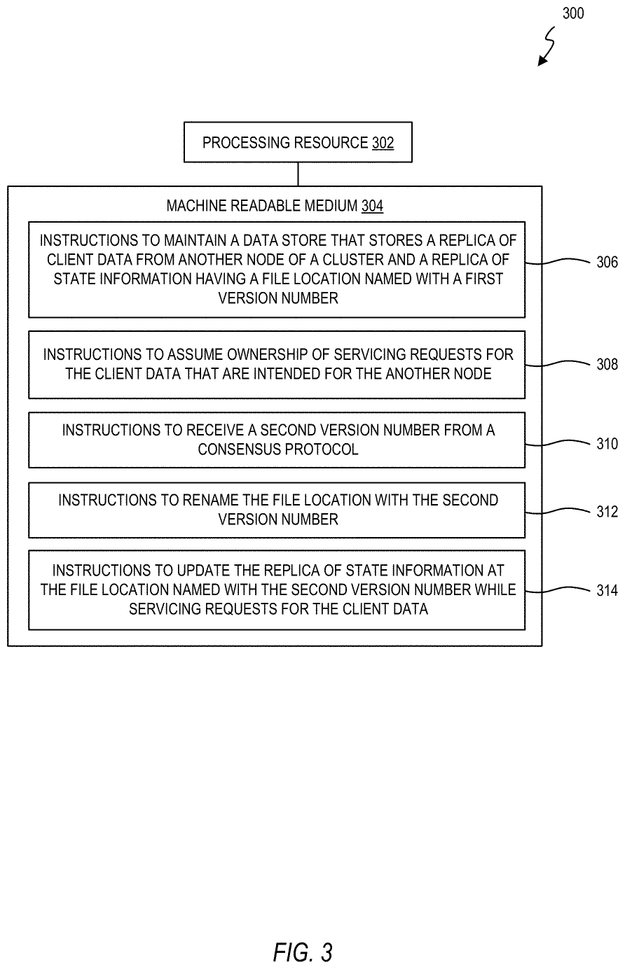

FIG. 3 depicts a processing resource 302 coupled to a non-transitory machine readable medium 304 encoded with example instructions 306, 308, 310, 312, 314. The processing resource 302 and medium 304 may be included in nodes of a cluster, such as node-1 102 or node-2 142 of cluster 100. The processing resource 302 and medium 304 may serve as or form part of processing resources 104, 144 and machine readable media 106, 146 respectively. The instructions of FIG. 3, when executed by the processing resource 302, may implement aspects of a virtual controller that renames a version number-based file location of state information to protect the state information from corruption. In particular, the instructions of FIG. 3 may be useful for performing the functionality of the virtual controller-2 148 of FIG. 1 or the second virtual controller of the sequence diagram of FIG. 2.

Instructions 306, when executed, may cause the processing resource 302 to maintain a data store (e.g., data store-2 160 of node-2 142) that stores a replica (e.g., 164) of client data (e.g., 124) from another node (e.g., 102) of the cluster (e.g., 100) and a replica (e.g. 162) of state information (e.g., 122) related to the client data. The state information has a file location named with a first version number.

Instructions 308, when executed, may cause the processing resource 302 to assume ownership of servicing requests for the client data that are intended for the another node. Instructions 308 may be part of a failover routine triggered by a network partition in the cluster that separates the node and the another node or triggered by other unavailability of the another node.

Instructions 310, when executed, may cause the processing resource 302 to receive a second version number (also referred to as a new or next version number) from a consensus protocol (e.g., 150). The second version number is different from the first version number embedded in the state information file location prior to the network partition, and in some implementations, the second version number may be a next increment higher than the first version number.

In an implementation, instructions 310 to receive the second version number may include instructions to retrieve a value of an extended attribute associated with the replica of state information, where the second version number is provided by the consensus protocol in the value. For example, a getxattr command may be used in the manner described above.

In another implementation, instructions 310 to receive the second version number may include instructions to read a virtual file having therein the second version number from the consensus protocol. For example, a /proc command may be used in the manner described above.

Instructions 312, when executed, may cause the processing resource 302 to rename the file location of the replica state information with the second version number received by execution of instructions 310. For example, instructions 312 may embed the second version number in a virtual disk name portion of the state information file location. In another example, instructions 312 may embed the second version number in a directory path portion of the state information file location.

In various implementations, instructions 310 and 312 may be executed to increment the version number and rename the file location of the replica state information based on the incremented version number in response to different conditions. For example, in an implementation, the consensus protocol may automatically increment the version number to the second version number as part of the failover routine, and instructions 310 and 312 may also be executed as part of the failover routine. In another example implementation, instructions 310 and 312 may be executed in response to a file protocol request to connect to the client data (e.g., open command), which may be serviced according to instructions 308 after the failover routine. In another implementation, instructions 310 and 312 may be executed after multiple conditions, such as after failover and in response to a connection request, in order to provide an additional level of safety.

Instructions 314, when executed, may cause the processing resource 302 to update the replica of state information at the file location named with the second version number. In particular, instructions 314 may be executed while servicing requests for the client data during the network partition, using the replica client data.

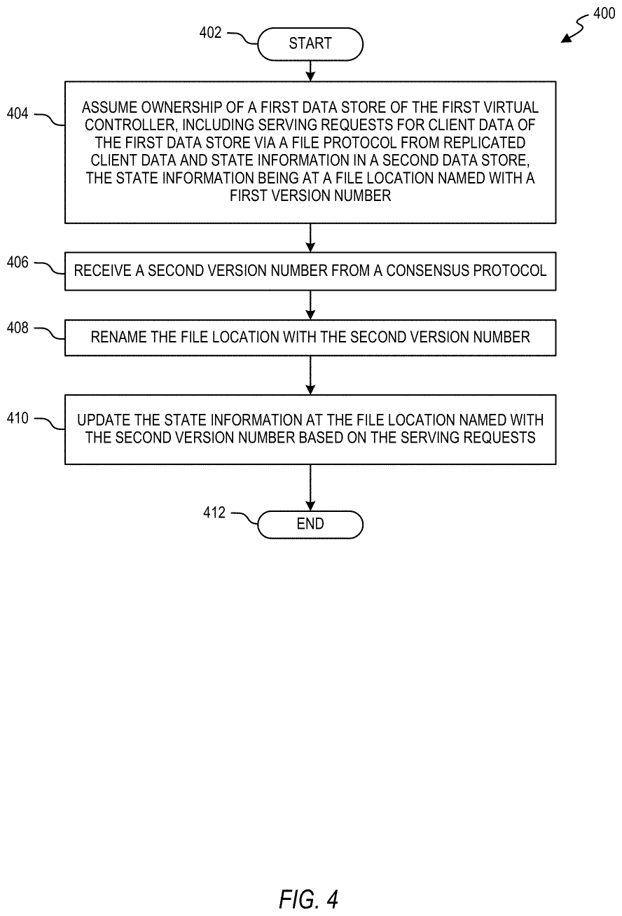

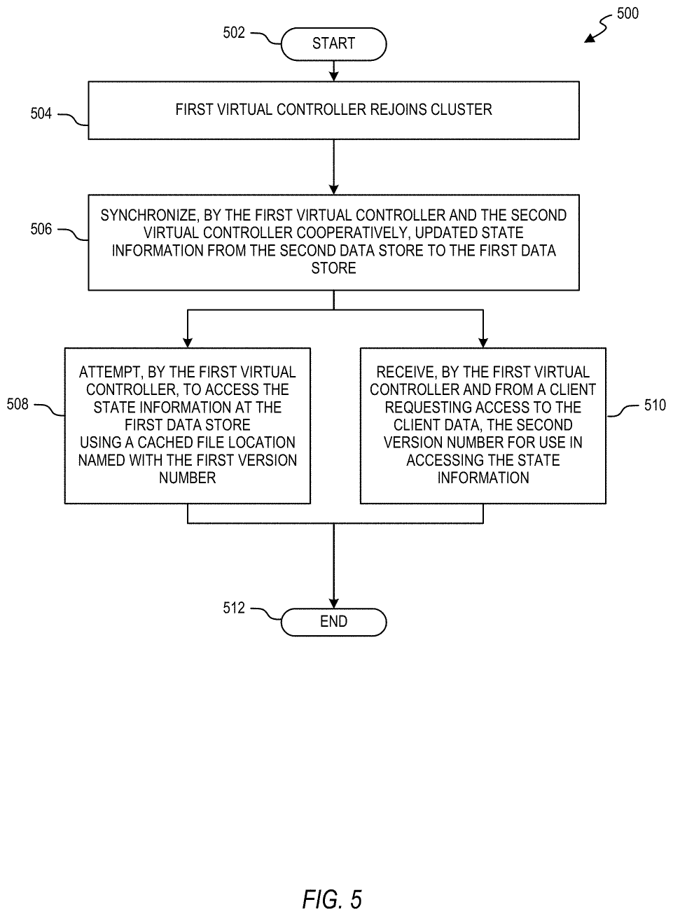

FIGS. 4 and 5 are flow diagrams depicting various example methods. In some implementations, one or more blocks of a method may be executed substantially concurrently or in a different order than shown. In some implementations, a method may include more or fewer blocks than are shown. In some implementations, one or more of the blocks of a method may, at certain times, be ongoing and/or may repeat.

The methods may be implemented in the form of executable instructions stored on a machine readable medium (e.g., such as machine readable medium 106, 146, or 304) and executed by a processing resource (e.g., such as processing resource 104, 144, or 302) and/or in the form of electronic circuitry. In some examples, aspects of the methods may be performed by the virtual controller-1 108, the virtual controller-2 148, or components thereof.

FIG. 4 is a flow diagram depicting an example method 400. Method 400 starts at block 402 and continues to block 404, where a second virtual controller (e.g., 148) responds to a network partition between a first virtual controller (e.g., 108) and the second virtual controller of a cluster (e.g., 100) by assuming ownership of a first data store (e.g., 120) of the first virtual controller. For example, assuming ownership may include the second virtual controller assuming the storage IP address (e.g., 114) of the first virtual controller and serving requests for client data (e.g., 124) of the first data store via a file protocol using replicated client data (e.g., 164) and state information (e.g., 162) in a second data store (e.g., 160) maintained by the second virtual controller. The state information may be located at a file location named with a first version number. For example, the version number may be embedded in a disk name or directory path of the state information.

At block 406, the second virtual controller may receive a second version number from a consensus protocol (e.g., 150). For example, the second virtual controller may use a getxattr command as described above to retrieve a value of an extended attribute associated with the state information, where the consensus protocol returns the second version number in the value of the extended attribute. In another example, the second virtual controller may use a /proc command as described above to read a virtual file having therein the second version number as provided by the consensus protocol. The second version number may come after the first version number in a monotonically increasing sequence (i.e., the second version number is greater than the first version number).

At block 408, the second virtual controller renames the file location with the second version number. For example, to rename the file location, the second virtual controller may embed the second version number in a virtual disk name portion of the file location or in a directory path portion of the file location.

At block 410, the second virtual controller may update the state information at the file location named with the second version number while serving requests with ownership of the first data store during the network partition. At block 412, method 400 may end.

FIG. 5 is a flow diagram depicting an example method 500. In some examples, method 500 may occur after method 400. Method 500 starts at block 502 and continues to block 405, where the first virtual controller rejoins the cluster. For example, a network partition may heal, thus reestablishing contact between the first virtual controller and the cluster. At block 506, the first virtual controller and the second virtual controller may cooperate to synchronize updated state information from the second data store to the first data store. For example, the state information may have been updated by block 410 of method 400.

At least two scenarios may occur after block 506. In block 508, the first virtual controller may attempt to access the state information at the first data store using a cached file location named with the first version number. The cached file location may have been cached by the first virtual controller prior to the network partition or first virtual controller unavailability. In some cases, the first virtual controller may be attempting to write stale data to the synchronized and updated state information. However, by virtue of the state information being at a file location named with a different version number (e.g., the second version number or another higher version number), the state information may be protected from corruption.

In block 510, the first virtual controller may receive, from a client requesting access to the client data, the second version number for use in accessing the state information. In particular, block 510 may occur if ownership of the first data store and client data has failed back to the first virtual controller. The first virtual controller may then resume a session as described in the synchronized and updated state information. At block 512, method 500 may end.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

What is claimed:

1. A system comprising:
a first node having a first virtual controller to provide a first data store that stores client data and state information related to serving the client data via a file protocol, the state information being maintained by a consensus protocol and being at a file location named with a first version number; and
a second node joined to a cluster including the first node, the second node having a second virtual controller to provide a second data store that stores replica client data and stores replica state information having the file location with the first version number,
wherein, after fail over of the first virtual controller to the second virtual controller, the second virtual controller:
receives a second version number from the consensus protocol,
renames the file location of the replica state information using the second version number, and
updates the replica state information at the file location renamed with the second version number based on the second virtual controller serving the replica client data.

2. The system of claim 1, wherein after healing of a network partition that caused the fail over, the first virtual controller and the second virtual controller synchronize updated replica state information from the second data store to the first data store.

3. The system of claim 2, wherein the first virtual controller caches the file location named with the first version number prior to the network partition, and
after the healing of the network partition and updated replica state information is synchronized, the first virtual controller is unable to access the state information using the cached file location named with the first version number.

4. The system of claim 2, wherein after healing of the network partition and updated replica state information is synchronized, the first virtual controller receives the second version number from a client requesting access to the client data.

5. The system of claim 1, wherein the state information relates to network connection of the file protocol to the client data.

6. The system of claim 1, wherein the second version number is embedded in a virtual disk name portion of the file location or in a directory path portion of the file location.

7. The system of claim 1, wherein the second virtual controller receives the second version number by retrieving a value of an extended attribute associated with the client data, the second version number being returned from the consensus protocol into the value.

8. The system of claim 1, wherein the second virtual controller receives the second version number by reading a virtual file having therein the second version number from the consensus protocol.

9. A method comprising:
responding to a network partition between a first virtual controller and a second virtual controller of a cluster by assuming, by the second virtual controller, ownership of a first data store of the first virtual controller, wherein ownership includes serving requests for client data of the first data store via a file protocol from replicated client data and state information in a second data store of the second virtual controller, the state information being at a file location named with a first version number;
receiving, by the second virtual controller, a second version number from a consensus protocol;
renaming, by the second virtual controller, the file location with the second version number, and
updating the state information at the file location named with the second version number while serving requests during the network partition.

10. The method of claim 9, further comprising:
rejoining the cluster, by the first virtual controller;
synchronizing, by the first virtual controller and the second virtual controller cooperatively, updated state information from the second data store to the first data store; and
attempting, by the first virtual controller, to access the state information at the first data store using a cached file location named with the first version number.

11. The method of claim 9, further comprising:
rejoining the cluster, by the first virtual controller; and
receiving, by the first virtual controller and from a client requesting access to the client data, the second version number for use in accessing the state information.

12. The method of claim 9, wherein the receiving the second version number includes retrieving a value of an extended attribute associated with the client data, the second version number being stored from the consensus protocol into the value.

13. The method of claim 9, wherein the receiving the second version number includes reading a virtual file having stored therein the second version number from the consensus protocol.

14. The method of claim 9, wherein the renaming embeds the second version number in a virtual disk name portion of the file location or in a directory path portion of the file location, and
the second version number comes after the first version number in a monotonically increasing sequence.

15. A non-transitory machine readable medium storing instructions executable by a processing resource of a node in a cluster, the instructions comprising:
instructions to maintain a data store of the node that stores a replica of client data from another node of the cluster and a replica of state information related to the client data, the state information having a file location named with a first version number;
instructions to assume ownership of servicing requests for the client data that are intended for the another node upon a network partition in the cluster that separates the node and the another node;
instructions to receive a second version number from a consensus protocol;
instructions to rename the file location with the second version number; and
instructions to update the replica of state information at the file location named with the second version number while servicing requests for the client data during the network partition.

16. The non-transitory machine readable medium of claim 15, wherein the instructions to receive the second version number include instructions to retrieve a value of an extended attribute associated with the replica of client data, the second version number being provided by the consensus protocol in the value.

17. The non-transitory machine readable medium of claim 15, wherein the instructions to receive the second version number include instructions to read a virtual file having therein the second version number from the consensus protocol.

18. The non-transitory machine readable medium of claim 15, wherein the instructions to rename embeds the second version number in a virtual disk name portion of the file location.

19. The non-transitory machine readable medium of claim 15, wherein the instructions to rename embeds the second version number in a directory path portion of the file location.

20. The non-transitory machine readable medium of claim 15, wherein the consensus protocol provides the second version number in response to a file protocol request to connect to the client data.
